(19) United States
(12) Patent Application Publication
(10) Pub. No.: US 2009/0026152 A1
(43) Pub. Date: Jan. 29, 2009

(54) MODULAR FILTER AND VACUUM HEAD ASSEMBLY FOR A FILTERING APPARATUS

(75) Inventors: Tony COLLINS, Fort Lauderdale, FL (US); Brett Boyd, Fort Lauderdale, FL (US); Bill Mattfeld, Fort Lauderdale, FL (US)

Correspondence Address: FOLEY AND LARDNER LLP;SUITE 500, 3000 K STREET NW, WASHINGTON, DC, 20007, US

(73) Assignee: Parkson Corporation

(21) Appl. No.: 12/142,705

(22) Filed: Jun. 19, 2008

Related U.S. Application Data
(60) Provisional application No. 60/945,220, filed on Jun. 20, 2007.

(51) Int. Cl. B01D 29/62

(52) U.S. Cl. 210/791; 210/247; 210/236

(57) ABSTRACT

The disclosed modular filter may include a filter medium and an external frame structure. The filter medium may form a chamber having a front side, a back side, and a periphery. The filter medium may also have a plurality of fibers. The external frame structure has at least one aperture mounted on at least one of the front side and back side of the chamber in which the external frame structure has a thickness greater than the lengths of the plurality of fibers.

### CROSS-REFERENCE TO RELATED APPLICATIONS

This application claims priority to U.S. provisional application No. 60/945,220 filed Jun. 20, 2007, the disclosure of which is incorporated herein by reference in its entirety.

### BACKGROUND OF THE INVENTION

The invention generally relates to a filtering apparatus, a modular filter, and a cleaning device for cleaning a modular filter, which can be used, for example, for the filtration of fluids such as wastewater.

The use of felt or pile fabrics in filtering media is known in the art. For example, U.S. Patent Application 2005/0139557 (hereinafter known as “the '557 publication”) discloses a tertiary filter using a filter cloth of long pile fibers in a wastewater processing method. This tertiary filter comprises a filter medium comprising fibers attached to a fabric backing and a peripheral framework upon which the filter medium is placed. The filter medium is placed in a container with an influent pipe leading to a dirty liquid chamber; clean liquid chambers which are separated from the dirty liquid chamber by the filter medium; a discharge box; and a discharge port. In operation, the wastewater enters the container via the influent pipe and fills the dirty liquid chamber. The wastewater liquid is filtered to remove solids from the liquid as the wastewater flows through the filter medium into the clean liquid chambers. The cleaned liquid then passes through the discharge box and discharged through the discharge port.

During use, the fibers of the filter medium are matted down and become clogged with solid particles that are removed from the liquid stream. The filter medium tends to permit less liquid to pass through due to clogging caused by solid particles trapped in the fibers. This constriction in flow causes the level of liquid in the dirty liquid chamber to rise.

To maintain suitable amounts of flow and to prevent the level of dirty liquid from rising too high, it is desirable to clean the filter medium so as to remove the clogging particles. One such method to clean the filter is proposed in U.S. Pat. No. 6,103,132 (hereinafter known as “the '132 patent”) in which a filter medium comprising fibers is backwashed with a suction head. The leading edge of the head exerts a mechanical pressure on the filter medium with an abrupt release of pressure causing the fibers to straighten abruptly within a suction slit in the suction head. A seal is created by pressing the suction head against the filter medium, which prevents liquid adjacent to the filter medium and the suction head from entering through the interface between the suction head and filter medium. Such a seal increases the efficiency of the cleaning operation but this approach has a few drawbacks. For example, the filter medium becomes worn due to the impingement of the leading (and trailing) edge of the suction head against the filter medium. In addition, the process can result in the fibers or parts of fibers being pulled out of the fiber backing, an enlargement of the apertures in the fiber backing, and/or a rupture of the fiber backing. With these consequences, the efficiency of the filter medium is lowered, and premature failure of the filter medium may occur. More importantly, this process can push solids through the filter medium into the clean water chamber, thus degrading the effluent quality.

In a different approach for cleaning a filter medium, the '557 publication states in its abstract that the “filter may be backwashed by a rotating suction head which does not touch the filter cloth. A combination of countercurrent and horizontal flow dislodges entrained solids from the filter cloth. Mounting of the filter media as modular components permits increased capacity within a single tank while avoiding down time in changeover of filter media.” Because the suction head does not touch the filter cloth, there is no wear and tear on the filter cloth due to such contact. However, a gap exists between the suction head and the filter cloth, i.e., there is no seal, which permits liquid adjacent to the filter medium and the suction head to enter through the gap. Consequently, there is a decrease in the efficiency of the cleaning operation.

Therefore, there is a need for a filtering apparatus and method that permits cleaning without shortening or diminishing the efficiency of the filter medium while effectively removing trapped solid particles that can reduce the throughput of the filter medium.

### SUMMARY OF THE INVENTION

According to one embodiment of the present invention, a modular filter may comprise a filter medium and an external frame structure. The filter medium may form a chamber having a front side, a back side, and a periphery, and may comprise a plurality of fibers. The external frame structure may have at least one aperture, and may include at least one plate structure disposed relative to the filter medium to inhibit the flow of fluid along the surface of the filter medium. The plate structure may have an external surface located at a distance from the filter medium such that the plurality of fibers does not extend substantially beyond the external surface.

According to another embodiment of the present invention, a filtering apparatus may comprise a container and at least one modular filter placed in the container. The modular filter may comprise a filter medium forming a chamber having a front side, a back side, and a periphery, and an external frame structure with at least one plate structure disposed relative to the filter medium to inhibit flow of fluid along the surface of the filter medium. The filter medium may comprise a plurality of fibers. The at least one plate structure may have an external surface located at a distance from the filter medium such that the plurality of fibers does not extend substantially beyond the external surface.

According to another embodiment of the present invention, a method of operating a filter apparatus may comprise providing at least one modular filter (in which the modular filter may comprise a filter medium forming a chamber having a front side, a back side, and a periphery, and an external frame structure mounted on the filter medium, wherein the filter medium comprises a plurality of fibers), flowing fluid containing particles through the modular filter in a first direction between the plurality of fibers and into the chamber, and providing at least one vacuum head assembly comprising at least one suction head. The suction head may contact the external frame structure of the at least one modular filter but does not substantially contact the plurality of fibers during a cleaning operation.

According to another embodiment of the present invention, a cleaning device for cleaning a modular filter may comprise a hollow shaft, a motor operatively connected to the hollow shaft, a vacuum source in fluid communication with the hollow shaft; and a suction head comprising a plurality of apertures in which the plurality of apertures are in fluid communication with the vacuum source via the hollow shaft. The suction head may be connected to the hollow shaft by a leaf spring for biasing the suction head against the modular filter.

It is to be understood that both the foregoing general description and the following detailed description are exemplary and explanatory only, and are not restrictive of the invention as claimed.

### BRIEF DESCRIPTION OF THE DRAWINGS

The features, aspects, and advantages of the present invention will become apparent from the following description, appended claims, and the accompanying exemplary embodiments shown in the drawings, which are briefly described below.

FIG. 1 is a side view of a filter apparatus according to an embodiment of the present invention.

FIG. 2 is a plan view of the filter apparatus shown in FIG. 1.

FIGS. 3A and 3B are cross-sectional views of the filter apparatus of FIG. 2 taken along sectional lines A-A and B-B, respectively.

FIG. 4 is an exploded view of a modular filter according to an embodiment of the present invention.

FIGS. 5A and 5B are perspective and front views, respectively, of a modular filter according to an embodiment of the present invention.

FIGS. 6A and 6B are side and front views, respectively, of an internal frame structure according to an embodiment of the present invention.

FIG. 7 is a front view of an external frame structure according to an embodiment of the present invention.

FIG. 8 is a front view of an external frame structure according to another embodiment of the present invention.

FIGS. 9A to D are schematic views showing the steps for removing a modular filter from a container according to an embodiment of the present invention.

FIGS. 10A and 10B are perspective and front views, respectively, of a modular filter according to another embodiment of the present invention.

FIGS. 11A and 11B are cross-sectional views of a filter apparatus using the modular filter of FIGS. 10A and 10B.

FIGS. 12A to 12D show a vacuum head assembly according to an embodiment of the present invention. FIG. 12A is a top view. FIG. 12B is a cross-sectional view taken along sectional line C-C in FIG. 12A. FIG. 12C is a side view without the tube. FIG. 12D is a bottom view without the tube.

FIG. 13 is a top view of a vacuum head assembly attached to a rotating shaft.

FIG. 14 is a side view of a rotating sprocket attached to a rotating shaft.

FIG. 15 is a cross-sectional view of the suction head applying a suction force to the plurality of fibers of the filter medium.

### DETAILED DESCRIPTION OF THE PRESENTLY PREFERRED EMBODIMENT

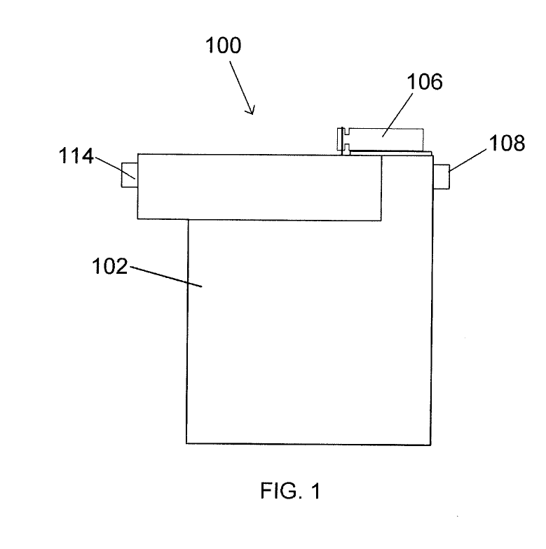

Various embodiments will now be explained with reference to the drawings. In FIGS. 1 to 3, a filtering apparatus 100 according to an embodiment of the present invention is shown. The filtering apparatus can be used in a wastewater treatment process or in other applications, such as process water pre-treatment. The filtering apparatus may comprise a container 102, at least one modular filter 104, and a cleaning mechanism 500.

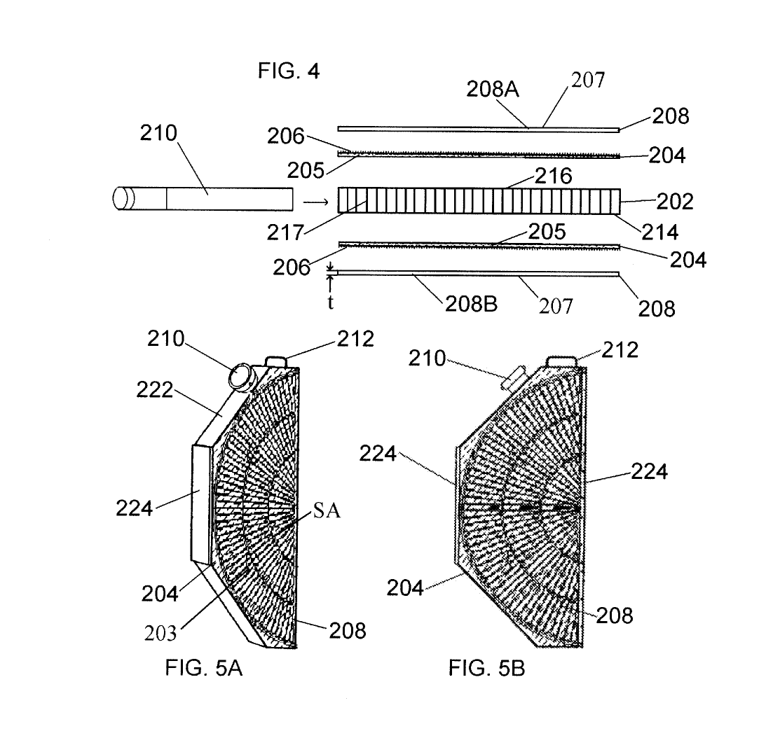

The container 102 is configured to hold the liquid to be filtered. It may be made from any suitable material, such as concrete, stainless steel, sheet metal, or the like. The container 102 may be generally one of many possible shapes, such as cuboid, cubic, cylindrical, trapezoidal, pyramidal, or the like. In a preferred embodiment, the container is substantially cuboid, as seen in FIG. 1. The container may have any suitable dimensions, but preferably it is about 5 to 9 feet wide, about 5 to 25 feet long, and between 6 to 10 feet high. The container may include an inlet 108, an influent collection section 110, an effluent collection section 112, and an outlet 114. The fluid to be treated, such as a liquid containing particles, wastewater, or the like (hereinafter referred to as the “untreated fluid”), enters as influent through the inlet 108 of the container 102 and collects in the influent collection section 110. The untreated fluid passes through the sides of the one or more modular filters 104 (thus filtering the fluid, i.e., the “treated fluid”) and collects in chambers 203 (see FIG. 3A) inside the one or more modular filters 104. Each modular filter 104 is equipped with a fluid outlet 210 connected to an output duct 116 (see FIG. 3B). The treated fluid flows through the fluid outlets 210 of the modular filters 104, through the output ducts 116, and into the effluent collection section 112. From the effluent collection section, the treated fluid exits the filtering apparatus through the outlet 114.

The inlet 108 and the outlet 114 are typical connections known in the art to permit flow into and out of the filtering apparatus 100 in a fluid treatment system. For example, the inlet and outlet can be flanged fittings, tubing, or ducts. Suitable materials for the inlet and outlet may be PVC or other suitable plastics, stainless steel or other suitable metals, or the like. The inlet 108 and the outlet 114 can be located at any suitable location on the external surface of the container 102. For example, either one or both of the inlet and outlet can be on an upper portion of the container 102 (as seen in FIG. 1) or on a lower portion of the container 102. Additionally, the inlet and outlet can be on the same side of the container 102 or on different sides, for example on opposing sides of the container, as seen in FIG. 1.

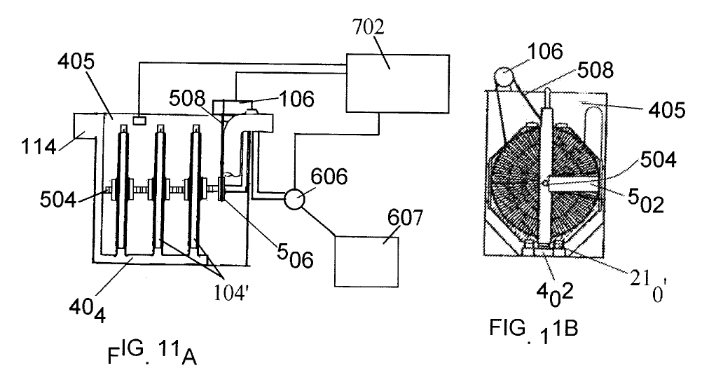

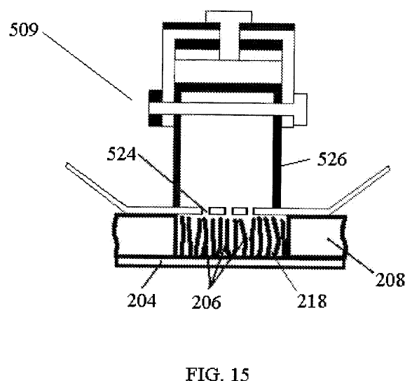

The influent collection section 110 can be any suitable shape but preferably is made up of internal surfaces of the container 102, which have a shape that conforms or accommodates the shape of the modular filter. For example, FIGS. 3A and 3B show modular filters that are substantially half an octagon. The influent collection section 110 has walls that are wide enough to accommodate two modular filters 104 so that they can be placed side by side. As shown in FIGS. 9A to 9D, the influent collection section 110 has a dividing post 306, which is used to support one side of each modular filter located toward the center of the influent collection section. The dividing post 306 has one or more supports 308 to support the weight of the modular filters. The influent collection section 110 also includes tracks 302 that project from the interior surface 304 of the container and/or tracks embedded in the surface of the dividing post 306 so as to retain the modular filters in their positions during operation. Such a track arrangement is disclosed in FIGS. 15, 15A, and 15B and paragraphs 0046 through 0061 of U.S. Patent Application Publication 2005/0139557, the entirety of which is hereby incorporated herein by reference. Thus, the influent collection section 110 is configured such that the interior surface 304 of the container, the dividing post 306, and the supports 308 accommodate the shape of the outer periphery of the modular filter so as to hold the modular filter in place during use.

In the embodiment of FIGS. 3A and 3B, the fluid outlet 210 is located at the top of the modular filter 104. The fluid outlet 210 is connected to one of the output ducts 116, which leads through an aperture 118 in the influent collection section into the effluent collection section 112. The effluent collection section may be a trough, a collection reservoir, or the like. The fluid in the modular filter 104 is able to exit through the fluid outlet 210 and into the effluent collection section 112 when the fluid level in the influent collection section (as well as in the modular filter 104) reaches a level above the output duct 116. The fluid outlet 210, the output duct 116, and the aperture 118 are sealed so that untreated fluid from the influent collection section 110 does not flow directly into the effluent collection section 112. From the effluent collection section 112, the treated fluid exits the filtering apparatus through the outlet 114.

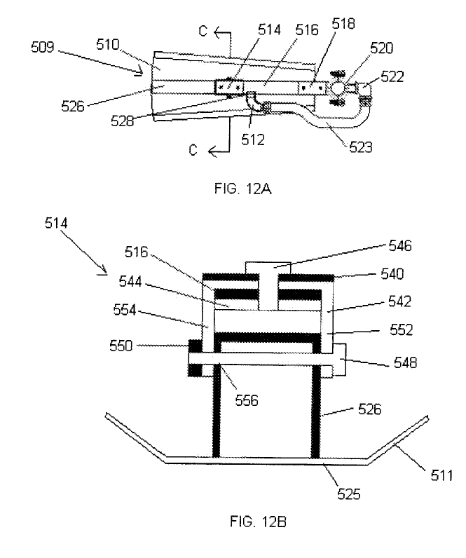

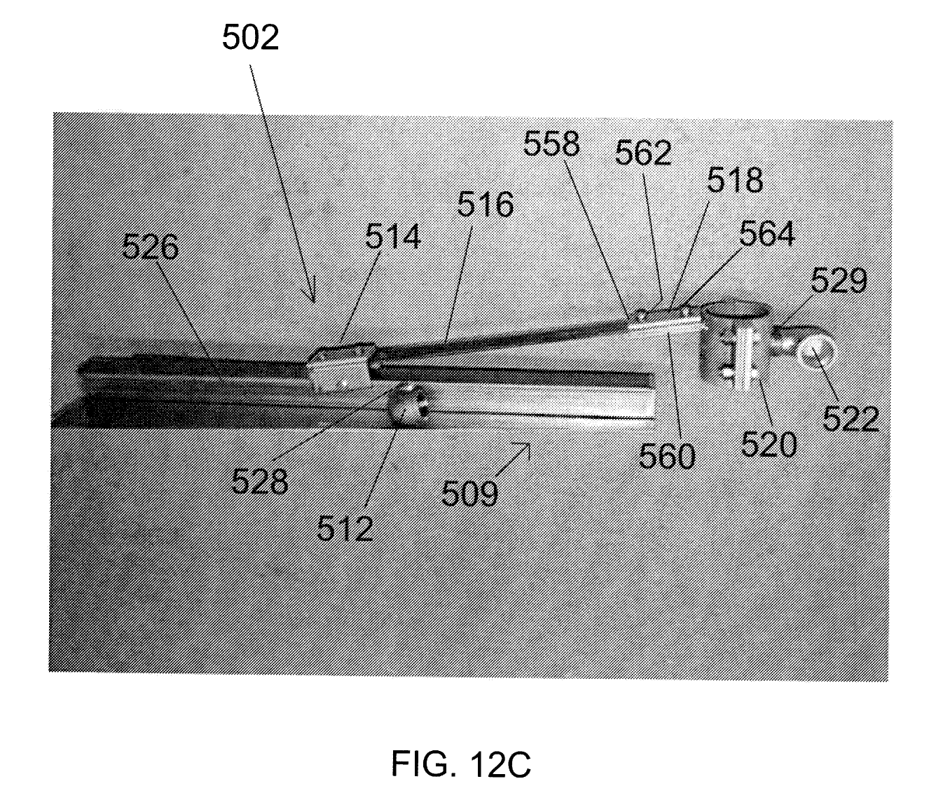

In an alternate embodiment shown in FIGS. 10, 11A, and 11B, the fluid outlet 210′ of the modular filter 104′ is located at the bottom of the filter, the fluid outlet 210′ is connected to an output block 402, which includes a passage from the fluid outlet 210′ to the effluent collection section 404. In this embodiment, the effluent collection section 404 may be a chamber, piping, or other conduit. The fluid in the modular filter 104′ is able to exit through the fluid outlet 210′ and into the effluent collection section 404 by gravity but the fluid in the effluent collection section 404 exits out the outlet 114 when the fluid level in the influent collection section reaches a level equal to or above the outlet 114. The fluid outlet 210′, the output block 402, and the effluent collection section 404 are sealed so that untreated fluid from the influent collection section 405 does not flow into the effluent collection section 404.

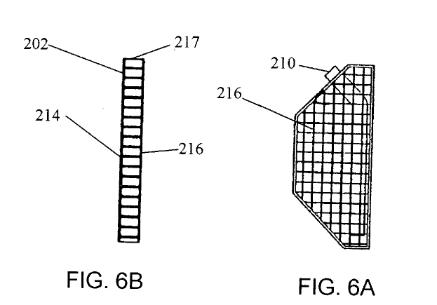

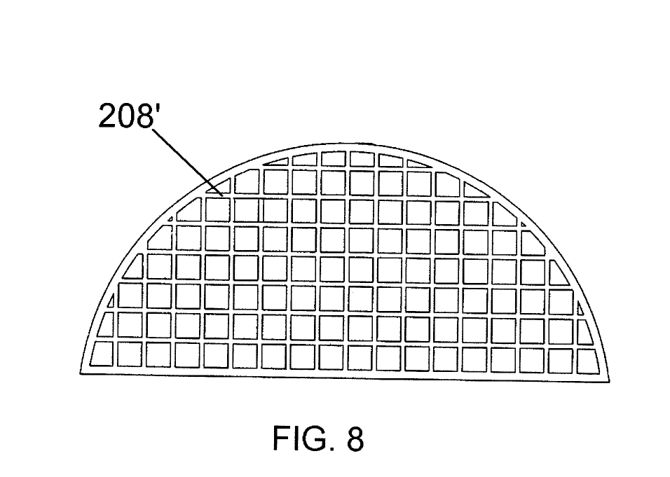

The modular filters 104 filter the untreated fluid. FIGS. 4 to 6 depict the modular filter 104 and its components, according to one embodiment of the present invention. The modular filter may take one of a variety of shapes. For example, the modular filter may have an overall cross-sectional shape that is substantially circular, semicircular, hexagonal, a hexagon cut in half, octagonal, an octagon cut in half, rectangular, or other polygonal shape. The modular filter may comprise an internal frame structure 202, a filter medium 204 mounted on the internal frame structure forming a chamber 203; an external frame structure 208 mounted on the filter medium, an outer peripheral frame 222 with a handle 212, and a fluid outlet 210.

The internal frame structure 202 may form the shape of the internal chamber of the modular filter. The internal frame structure 202 can comprise two grid-like faces 214 and 216. The grid-like faces 214 and 216 can be, for example, plates with apertures, a series of rods or wires attached together, a thin or course mesh, or the like. The grid-like faces can be formed in any suitable pattern so long as fluid can flow through the grid faces into the chamber. The two grid-like faces can be connected by various tie-bars 217. The tie-bars and grid-like faces can be attached to each other by any known means in the art, such as mechanical fasteners (such as screws, rivets, clamps, or the like), welding, brazing, adhesives, or the like. The materials for the grid-like faces and the tie-bars can be any suitable material such as stainless steel or other metal or molded plastics. The internal frame structure can vary in size. For example, the nominal diameter of the internal frame structure can range from about 25 to 200 inches, preferably up to about 84 inches. The thickness of the internal frame structure can be defined as the distance between the outer surface of one grid-like face 214 to the outer surface of the other grid-like face 216, and can range from about 2 to 10 inches, preferably about 6 inches.

The filter medium 204 may be placed over each side of the internal frame structure 202 so as to form a chamber 203 in the internal frame structure 202 in which filtered fluid is to collect. The filter medium 204 may comprise a plurality of fibers 206 supported by a backing or substrate 205.

The plurality of fibers 206 may comprise one or more of a pile fabric, a cloth polypropylene felt, or other inert material, such as a polymer. If a pile fabric is used, for example, it may have a long-napped filter cloth or pile comprised of a plurality of fibers 206 up to about 15 mm in length. It is recognized that it is within the scope of the invention to use larger or shorter lengths for the fibers provided that they do not extend beyond the apertures in the plate structures of the external frame structure as described below.

The substrate 205 can be a woven or non-woven fabric. To facilitate the flow of fluid into the chamber 203, the substrate 205 may comprise apertures of a suitable size such as in the range of about 5 to 15, but preferably about 10 microns in diameter. Once the plurality of fibers 206 are attached to the substrate 205, the filter medium including the plurality of fibers can be, for example, about 3 to 5 mm thick when fluid is flowing through the filter medium.

Besides the above disclosed filter medium, other media capable of filtering out a desired solid may be used. For example, suitable filter media are described in U.S. Pat. No. 6,103,132 and Netherlands Patent No. 8103750, both incorporated herein by reference in their entireties.

The filter medium 204 is attached to the internal frame structure 202 such that the plurality of fibers 206 of the filter medium face away from the exterior of the chamber 203, i.e., fiber side out. In one embodiment, the filter medium may be attached at one or more points within its periphery to the internal frame structure 202 for example, by rivets, either independently or in conjunction with the attaching mechanisms used to attach the external frame structure 208 to the internal frame structure 202. In another embodiment, the filter medium may be merely wrapped around the entire internal frame structure 202 and sewn or otherwise attached to itself; thus enclosing the internal frame structure within the filter medium. Additionally, the size of the filter medium may be varied relative to the internal frame structure so as to facilitate attachment to the internal frame structure. For example, the filter medium may be one-piece or a plurality of pieces sewn or otherwise attached to each other that is stretched over the entire exterior of the internal frame structure.

Attached to the filter medium 204 is the external frame structure 208. This structure is used to protect the plurality of fibers so that they do not get worn, damaged, or removed during the cleaning operation (to be described below). The external frame structure 208 may include a first plate structure 208A and/or a second plate structure 208B. In one example, the first and second plate structures are plates that attach to either the internal frame structure 202 or to each other so as to sandwich the filter medium and the internal structure therebetween. The frame structure 208, and particularly the first and/or second plate structure, preferably are made from plastic, such as, but not limited to, PVC, polyethylene, polypropylene, or other suitable plastic or a fiberglass material.

Each of the first and second plate structures can be described in terms of overall surface area SA, plate thickness t, and aperture configuration. These characteristics will be described below.

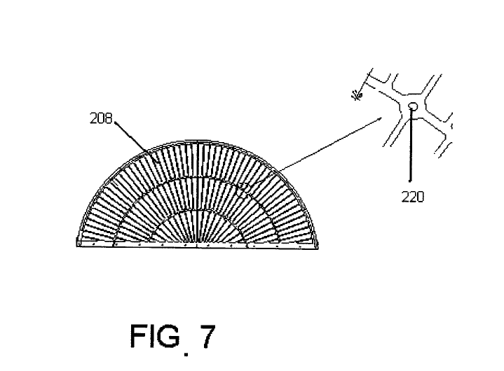

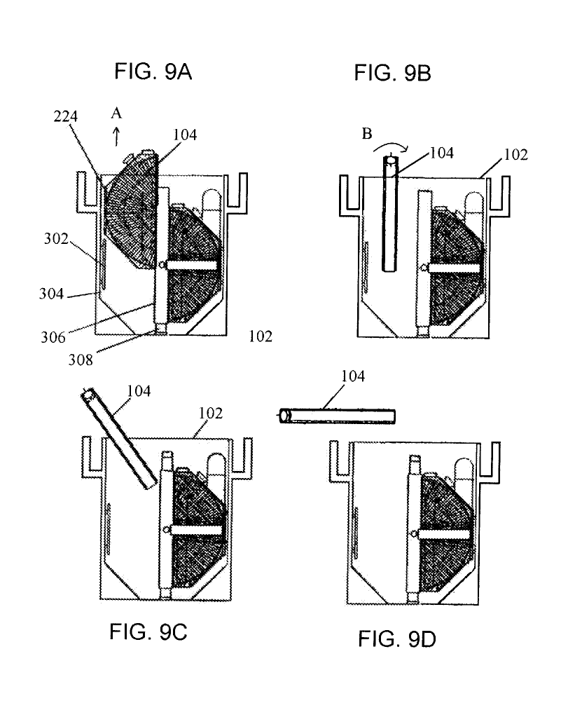

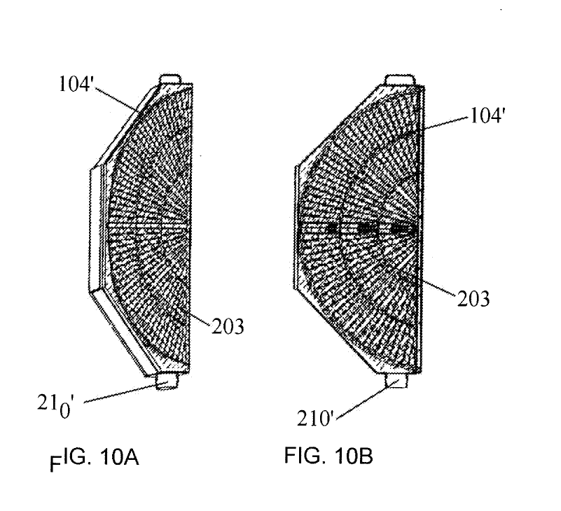

The overall surface area SA of the first and/or second plate structure may be the same as the grid-like faces 214 and 216 of the internal frame structure and may have the same shape, for example octagonal. In an example of such an embodiment, the external frame structure and the internal frame structure may be octagonal while the apertures in the external frame structure may cover a semi circular area of the filter medium (i.e., the corners of the octagonal external frame structure do not have apertures). This configuration would prevent flow through the corners of the octagonal shaped filter module. Alternatively, the plate structures of the external frame structure 208 may be of a shape different from the grid-like faces, for example, the internal frame structure may be octagonal while the plate structures of the external frame structure are semi-circular as seen in FIGS. 5A and 5B. Furthermore, the size of the first and second plate structures may be varied depending on the size of the grid-like faces 214 and 216 of the internal frame structure. In the exemplary embodiments of FIGS. 7 and 8, the shape of the plate structure of the external frame structure 208 and 208′, respectfully, may have, for example, an overall diameter of 55.25 inches. Of course, other dimensions for the overall diameter can be used as required

The plate thickness t of the first and second plate structures can be determined by the length of the fibers 206 in the filter medium 204. The plate thickness t of the first and second plate structures is dimensioned such that an external surface 207 of the plate structure, for example the surface 207 facing away from the filter medium 204, is located at a distance from the filter medium 204 so that the plurality of fibers 206 do not extend substantially beyond the external surface, such as during the application of a vacuum. In this context, “substantially beyond the external surface” would encompass the situation when most of the plurality of fibers (such as over half, over two-thirds, or over three-quarters of the fibers) of the filter medium (but not all the fibers) do not extend beyond the external surface of the plate structure when the fibers are standing erect from the backing or substrate 205. In a preferred embodiment, the plate thickness t is greater than the length of all the fibers of the filter medium when they stand erect from the backing or substrate 205. For example, the external frame structure may have a thickness ranging from ⅜ to one inch.

According to one embodiment, the plate thickness t of the first plate structure may be the same thickness as the second plate structure. According to another embodiment, the first and second plate structures may have different thicknesses. In yet another embodiment, the plate thickness t of the first plate structure and/or the plate thickness t of the second plate structure is/are substantially uniform.

The first and/or second plate structure includes at least one aperture 218, but preferably a plurality of apertures. The aperture exposes the filter medium 204 to the untreated fluid such that the fluid to be filtered flows through the aperture(s) in the plate structure 208A or 208B, through the filter medium 204 and into the chamber 203 of the modular filter. In other words, the external frame structure may inhibit the flow of fluid along the surface of the filter medium but the aperture allows fluid to pass from the dirty side of the filter to the clean side of the filter. The apertures may take a variety of shapes including, for example, substantially wedge-shaped in a fan-like configuration as in FIG. 7 or substantially square-shaped in a grid-like configuration as in FIG. 5. Other shapes for the aperture(s) may include triangular, oval, trapezoidal, and circular. In the embodiment of FIG. 7, the plate structure for the external frame structure 208 may have, for example, substantially wedge-shaped apertures about 1.25 inches wide and having a length ranging from 7 to 12 inches. In the embodiment of FIG. 8, the plate structure for the external frame 208′ may have, for example, substantially square apertures about 2.5 inches wide by 2.5 inches long. Of course, other dimensions for these apertures can be used as required.

The external frame structure 208 may also comprise a plurality of smaller apertures 220, which can be countersunk for bolts for the attachment of the external frame structure 208 to the rest of the modular filter. For example, bolts can be fed through the apertures 220 of the external frame member 208, through corresponding apertures in the filter medium 204, and screwed into corresponding threaded apertures in the internal frame structure 202. Alternatively, bolts can be fed through the apertures 220 of the first plate structure 208A of the external frame member 208, through corresponding apertures in the filter medium 204, through apertures in the internal frame structure 202, through apertures in the filter medium 204 on the opposite side of the internal frame structure, and screwed into corresponding threaded apertures in the second plate structure 208B of the external frame structure. Although the smaller apertures are seen in FIG. 7, these apertures can be equally applied to any plate structure of the external frame structure, such as the one shown in FIG. 8.

Once the external frame structure is placed on the filter medium 204 and the internal frame structure 202, the overall dimensions of the modular filter may range from about 2 to 10 inches thick and from about 25 to 200 inches in nominal diameter. Of course, other overall thicknesses, diameters, and shapes (different from those listed above) can be used.

Before or after the external frame structure is attached to the filter medium 204 and the internal frame structure 202, an outer peripheral frame 222 may be optionally attached about the periphery of the filter medium-covered internal frame structure 202, as seen in FIGS. 5A and 5B. The outer peripheral frame 222 may comprise a series of plates that can be attached to the external frame structure, to the internal frame structure via apertures in the filter medium, to the filter medium itself and/or to adjoining plates of the peripheral frame. The method of attachment of the plates of the peripheral frame may be any method known in the art, for example, by screws, rivets, adhesives, or the like. The peripheral frame can be any known material, such as stainless steel or other metal or plastic.

The outer peripheral frame may comprise one or more handles 212. The handle 212 is used by an operator for grabbing the modular filter and removing it from the container 102.

The outer peripheral frame also may comprise two outer protrusions 224 (shown in FIG. 5A) that mate into corresponding tracks or guide rails 302 in the container 102 so that the modular filter can be installed or removed from the container 102 (as shown in FIGS. 9A to 9D). The outer protrusions 224 slide into the corresponding tracks 302 in the container so as to hold the modular filter in place during use. In FIGS. 9A to 9D, the tracks 302 project from the interior surface 304 of the container 102. Tracks also can be embedded in the surface of the dividing post 306. It should be pointed out that, alternatively, instead of the modular filter having the protrusions and the container having tracks, the modular filter may have the tracks and the container may have the protrusion. Of course, other forms of connection between the modular filter and the container can be used for securing the modular filter in the container.

The fluid outlet 210 of the modular filter 104 provides a passage for the treated fluid in the chamber 203 to flow out of the modular filter and into the effluent collection section of the container 102. The fluid outlet 210 may be, for example, an output tube or duct. In one embodiment, the fluid outlet 210 may be made from PVC or other suitable plastic, stainless steel or other suitable metal, or the like. The fluid outlet extends inside the chamber 203 and extends through the internal frame structure 202, the filter medium 204, and the outer peripheral frame 222. The fluid outlet 210 can be placed at any suitable location on the modular filter, such as at the top of the filter as seen in FIGS. 5A and 5B or at the bottom as seen in FIGS. 10A and 10B. If the fluid outlet 210 is connected at the top, there are additional benefits such as easier visual and analytical inspection of the effluent quality, easier access for internal chemical cleaning, and easier replacement.

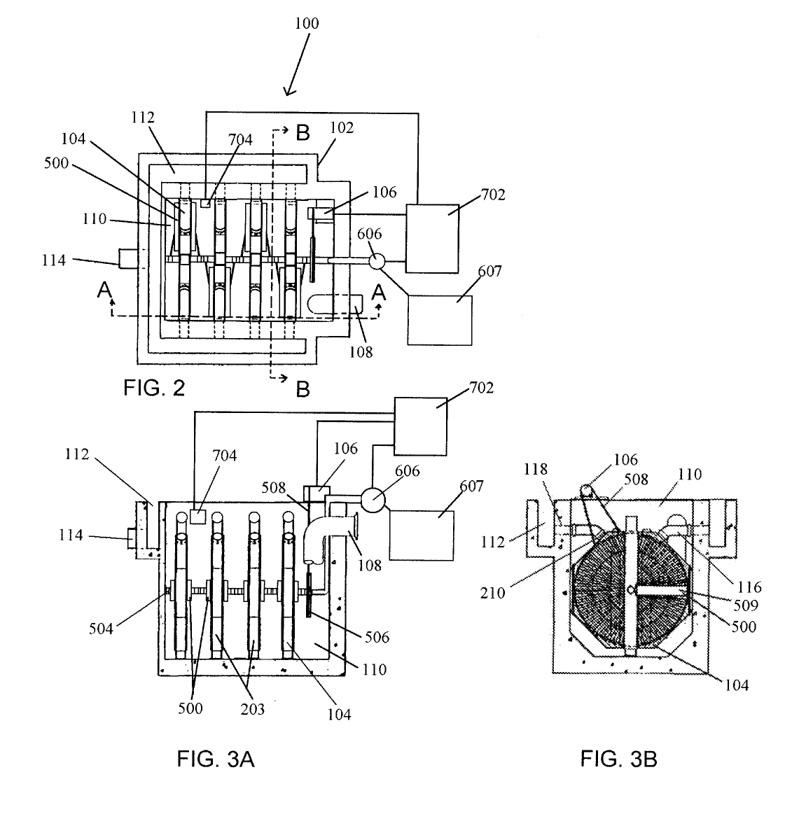

As previously mentioned, in the embodiment where the fluid outlet 210 is located at the top of the filter as seen in FIGS. 2, 3A, and 3B, the fluid outlet 210 is connected to the output duct 116, which leads through the aperture 118 in the influent collection section into the effluent collection section 112. The fluid in the modular filter is able to exit through the fluid outlet 210 and into the effluent collection section 112 when the fluid level in the influent collection section reaches a level above the output duct 116. From the effluent collection section 112, the treated fluid exits the filtering apparatus through the outlet 114. In the embodiment where the fluid outlet 210′ is located at the bottom as seen in FIGS. 10, 11A, and 11B, the fluid outlet 210′ is connected to an output block 402, which includes a passage from the fluid outlet 210′ to the effluent collection section 404. The fluid in the modular filter is able to exit through the fluid outlet 210 and into the effluent collection section 112 by gravity but the fluid in the effluent collection section 112 exits out the outlet 114 when the fluid level in the influent collection section reaches a level above the outlet 114.

After extended use of the filtering apparatus, the particles and other solids captured by the filter medium 204 in the modular filter 104 begin to accumulate, and eventually start to clog the flow of fluid through the filter medium. To diminish the effect of this clogging, the modular filters are periodically cleaned using a cleaning mechanism 500 schematically shown in FIGS. 3A, 3B, 11A, and 11B. The cleaning mechanism may include a vacuum head assembly 502, a rotating shaft 504 (which would be fed through apertures in the dividing post 306, if present), a rotating sprocket 506, a driving belt 508, a motor 106, a fluid level sensor 704, and a controller 702.

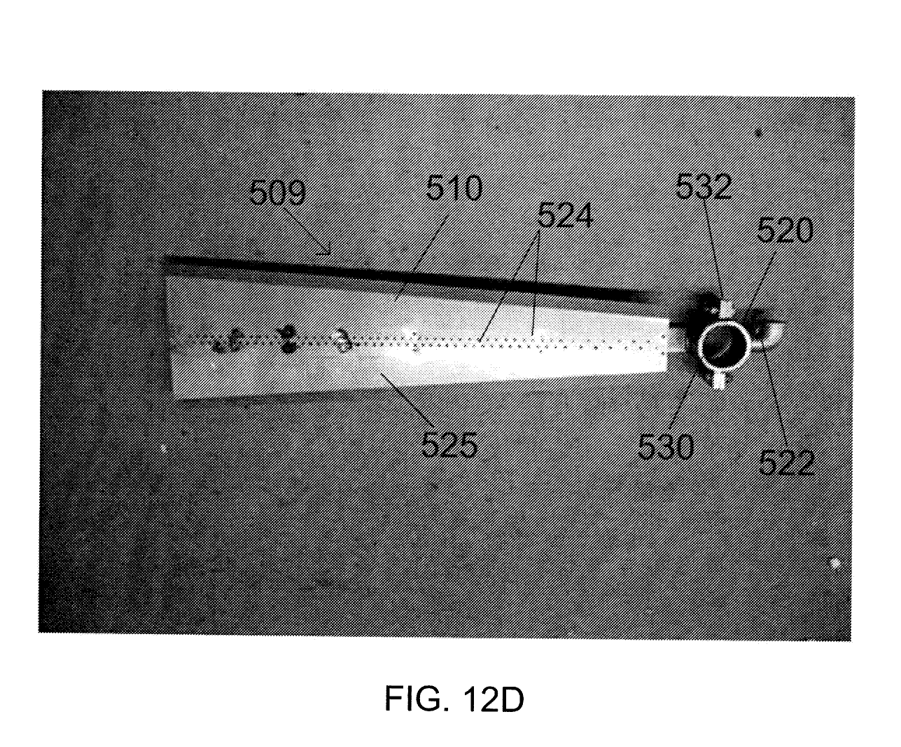

FIGS. 12A to 12D disclose detailed views of the vacuum head assembly 502. The vacuum head assembly 502 is configured to provide a vacuum pressure to the external frame structure 208 so as to cause the fluid inside the chamber 203 of the modular filter 104 to flow in the reverse direction through the filter medium 204; thus dislodging the particles accumulated in the filter medium with the reversed flow and removing them through the vacuum head assembly.

The vacuum head assembly 502 is in fluid communication with a vacuum source 606 by way of a vacuum connection pipe 602, a rotating shaft 504, a clamp assembly 520, and a flexible tube 523. The vacuum head assembly 502 may comprise a suction head 509 connected to a leaf spring 516 via a first bracket 514. The leaf spring 516 is then attached to the clamp assembly 520 via a second bracket 518. Thus, the clamp assembly fixedly attaches the suction head 509 to the rotating shaft 504.

The suction head 509 may include a face plate 510 and a vacuum chamber 526. The face plate 510 may be a sheet metal (for example, a stainless steel or other suitable metal) of any suitable shape, such as rectangular, trapezoidal, triangular, or the like. In FIGS. 12A to 12D, the face plate 510 is substantially fan-shaped with optionally upturned edges 511. The upturn edges allows the face plate 510 to ride over any obstructions on the external frame structure during the cleaning process. On one side of the face plate is a substantially flat surface 525 with a plurality of apertures 524; and on the other side of the face plate is the vacuum chamber 526. As for the apertures 524 along the surface of the flat surface 525, they can be any suitable size and shape, preferably in the range of one-fourth to one-half inch. In addition, any suitable aperture configurations can be used. For example, FIG. 12D shows the configuration of apertures 524 to be substantially two rows of apertures. Other configurations of apertures may be used including, but not limited to: one or more rows of apertures running along the length of the face plate (such as in FIG. 12D), apertures in staggered or non-staggered arrangements, apertures in a fan-shape configuration in which the area covered by the apertures increases along the length of the face plate, a rectangular configuration in which the area covered by the aperture remains constant along the length of the face plate but the number of apertures increases along the length of the rectangular area (i.e., hole density increases going from one end of the area covered by the apertures to the other), apertures that are oval slots, apertures in a configuration is which the size of the apertures increases when going from one end of the face plate to the other (i.e., along the length of the face plate), and the like. The size, quantity, and configuration of the apertures 524 may be selected so that every part of the filter medium is evenly cleaned. The size and quantity of the apertures 524 may be determined so that each aperture receives an equal portion of flow.

The vacuum chamber, on the other hand, can be substantially a cuboid, a prism, a half-cylinder, or other suitable shape. The vacuum chamber is either attached to the flat plate 510 by welding, brazing, mechanical fastening, or the like, or be integrally part of the flat plate 510 so that there are no leaks into the vacuum chamber. For example, FIGS. 12A to 12C show that the vacuum chamber 526 of the face plate 510 may be a sealed cuboid chamber attached to or integrally formed with the face surface 525. The vacuum chamber 526 covers and is in fluid communication with the apertures 524 of the flat plate 510. Also, the vacuum chamber is in fluid communication with the connector 512, which attaches to an aperture 528 attached to a side of the vacuum chamber 526. For example, the aperture 528 can have female threads that mate with male threads on the connector 512.

The connector 512 is connected to one end of a tube 523. The other end of the tube 523 is connected to another connector 522, which is attached to the clamp assembly 520. The connectors 512 and 522 can be a combination of piping and tube connectors (for example, an elbow pipe connected to a barbed tubing connector) or may be a single piece connector. The tube 523 can be may suitable material, such as a 1 inch diameter plastic hose, for example, poly(vinyl) chloride, polyethylene, or polyurethane.

The clamp assembly 520 may be a cylindrical bracket which clamps around the rotating shaft 504. For example, FIG. 12D shows a clamp formed from two half cylinders 530 with two flanges 532 on either end. The flanges 532 have bolt apertures (such as two bolt apertures), which are used to clamp the two half cylinders around the rotating shaft. One half cylinder has an aperture 529 in which the connector 522 is attached. For example, the aperture 529 can have female threads that mate with male threads on the connector 522. The clamp assembly 520 covers an aperture on the circumferential surface of a hollow rotating shaft 504, which is in fluid communication with the vacuum source 606.

The face plate 510 is attached to the clamp assembly 520 on the rotating shaft 504 through an arm assembly attached to the vacuum chamber. The arm assembly may comprise a first bracket 514, a leaf spring 516, and a second bracket 518.

As seen in FIG. 12B, the bracket 514 may comprises an upper flat plate 540, an intermediate C-shaped plate 542, and a lower flat plate 544. The upper plate has one or more apertures so that one or more bolts 546 can be fed through it. The one or more bolts 546 then feeds through corresponding apertures in the intermediate plate 542 and the leaf spring 516, and into a threaded aperture in the lower plate 544. This sandwich structure keeps the leaf spring 516 attached to the intermediate plate 542. Alternatively, the lower plate 544 may have an unthreaded aperture in which the bolt 546 is fed through and screwed into a nut. The intermediate plate 542 is then attached to the vacuum chamber 526 via one or more bolts 548 that are fed through one or more apertures in a side arm 552 of the intermediate plate 542 plate, through one or more corresponding apertures 556 in the vacuum chamber 526, through another aperture in side arm 554 and into a nut 550. This arrangement attaches the intermediate plate 542 (with the attached leaf spring 516) to the vacuum chamber 526, which is attached to the face plate 510. Suitable seals, such as O-rings or adhesives can be used to seal the apertures 556 in the vacuum chamber so as to prevent leaks. It may be advantageous to use only one bolt 548 such that the intermediate plate 542 can slightly pivot or rotate about the bolt 548. Such rotation will help facilitate the face surface 525 sitting flat on the external frame structure 208. As can be seen in FIG. 12C, the leaf spring 516 extends at an angle from the top surface of the vacuum chamber 526.

The leaf spring 516 may be any suitable shape, such as rectangular slat, and be any suitable material, such as fiberglass or other flexible material. According to alternative embodiments, a piston spring or a coil spring may be used instead of the leaf spring. Attached to the other end of the leaf spring 516 is the clamp assembly 520, which is attached by the second bracket 518.

The second bracket 518 comprises a top flat plate 558 and a bottom flat plate 560. The top flat plate 558 may simply be a rectangular piece of material, such as metal, with one or more apertures 562 to accommodate bolts 564. The leaf spring 516 has apertures that align with the one or more apertures 562 in the top flat plate 558. The bottom flat plate 560 may be a rectangular piece of material, such as metal, that is either attached to or integrally part of one of the half-cylinders 530 of the clamp assembly 520. For example, the bottom flat plate 560 can be attached to the half-cylinder by welding, brazing, mechanical fasteners, or the like. The bottom flat plate 560 may protrude from the clamp assembly at an angle from the longitudinal axis of the clamp assembly 520. For example, the clamp assembly can be 75°, 80°, 85°, or 90° from the longitudinal axis. The bottom flat plate 560 may have apertures which align with the apertures 562 of the top flat plate 558 so that the bolts can be fed through them. The apertures in the bottom flat plate may be threaded so that the bolts screw into the apertures of the bottom flat plate or the apertures may be unthreaded such that the bolts are fed through the apertures in the bottom flat plate and screw into nuts on the opposite side of the bottom flat plate. When the bolts are fed through the apertures in the top flat plate 558, the leaf spring 516, and the bottom flat plate 560 and screwed into the nuts on the other side of the bottom flat plate 560 (or into the threads in the apertures of the bottom flat plate), this sandwich structure attaches the leaf spring 516 to the clamp assembly 520. Thus, the leaf spring is now attached to the clamp assembly 520 at the one end and to the vacuum head assembly 502 at the other end.

The arm assembly preferably provides at least two functions. First, because the vacuum head assembly is fixedly attached to the rotating shaft via the arm assembly, the suction head 509 will rotate with the rotating shaft, which results in the suction head sweeping across the external frame structure 208 during the cleaning operation.

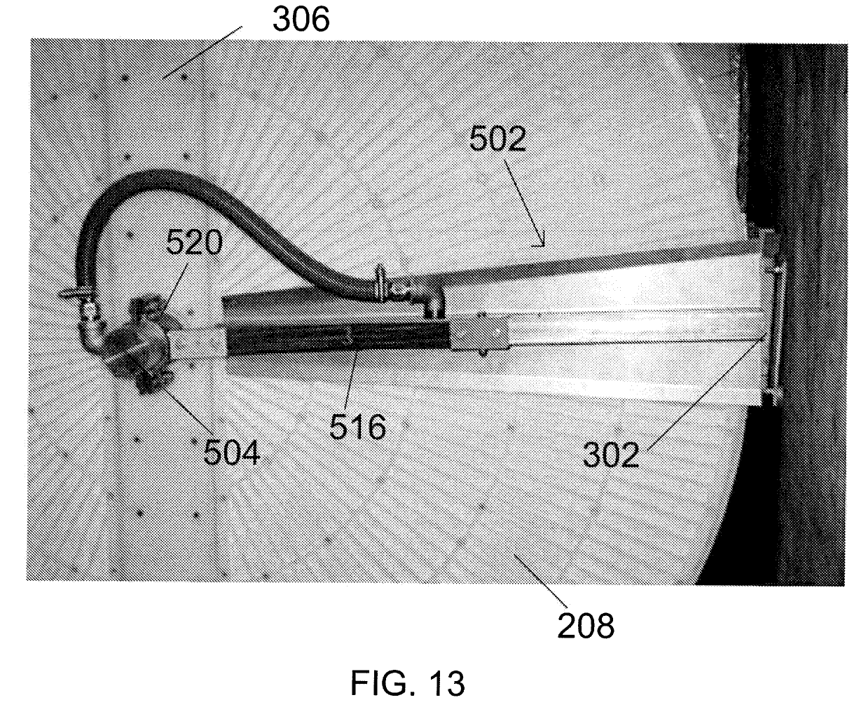

Second, the arm assembly with its leaf spring permits a biasing force from the vacuum head assembly to the external frame structure of the modular filter. This biasing force is accomplished by placing the second bracket on the rotating shaft 504 at a location so that the leaf spring is flexed when the face plate rests on the external frame structure. The flexing of the leaf spring creates the biasing force which will allow the suction head of the vacuum head assembly to sit firmly on the external frame structure and firmly ride on the external frame structure as it sweeps across the external frame structure during the cleaning process, as seen in FIG. 13.

The biasing of the face plate of the vacuum head assembly against the external frame structure provides advantages over conventional cleaning systems. For the conventional cleaning system (such as the '132 patent), the suction head exerts a force on the filtering medium causing damage to the filter medium, as discussed above. An attempt to move the suction head backward so that it does not exert a force on the filter medium may result in a gap between the suction head and the filter medium into which fluid adjacent to the suction head and filter medium can flow. With this gap, there is a greater likelihood that the adjacent wastewater will be subject to the suction force created by the suction head instead of the particles/sludge caught in the filter medium. In contrast, according to an embodiment of the present invention, the biasing force causing the vacuum head assembly to firmly rest on the external frame structure prevents damage to the filter medium because the vacuum head assembly is not directly impinging on the filter medium, and at the same time, providing a sealing function so as to diminish, preferably eliminate, the ability of any fluid adjacent to the modular filter in the influent collection section (i.e., fluid not in the chamber 203 of the modular filter) from being sucked into the vacuum head assembly 502. In other words, a substantial seal is created between the suction head of the vacuum assembly and the filter medium by using the biasing force of the suction head against the external frame structure which substantially inhibits fluid flow between the interface of the suction head and the external frame structure while, at the same time, ensuring that the suction head does not significantly come into contact with the filter medium. The thickness of the plate structure of the external frame structure will substantially prevent any contact between the fibers of the filter medium and the vacuum head assembly, i.e., the plate structure has a thickness such that the lengths of the apertures are substantially longer than the lengths of the fibers. However, it is preferable to ensure that the suction head does not make any contact at all with the filter medium by using a plate structure having a thickness such that the lengths of the apertures are longer than all the lengths of the fibers.

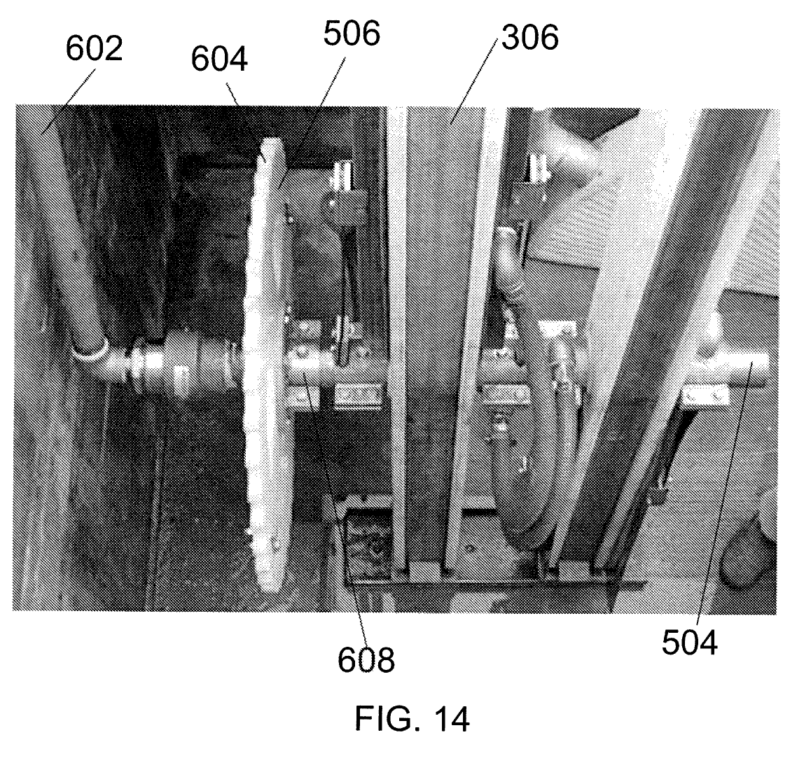

In addition to the vacuum head assembly, the cleaning mechanism 500 also comprises a rotating shaft 504. The rotating shaft 504 has a hollow interior which is connected to a vacuum source. The rotating shaft also has at least one aperture along its circumferential surface, and the clamp assembly 520 covers the at least one aperture. Thus, the vacuum inside the hollow interior of the rotating shaft 504 is in fluid communication with the aperture 529 in the clamp assembly (which eventually leads to the vacuum chamber 526 of the vacuum head assembly). The rotating shaft/clamp assembly interface also has a suitable seal which prevents any fluid from seeping between the rotating shaft and the clamp assembly. The hollow interior of the rotating shaft 504 is sealed at one end by an end cap or the like (as seen in FIG. 13) and connected to the vacuum connection pipe 602 at the other (as seen in FIG. 14).

FIG. 14 shows the rotating shaft 504 connected to the rotating sprocket 506 and a vacuum connection pipe or tube 602 (note that the modular filter 104 and the driving belt 508 are not shown). The vacuum connection pipe 602 connects to the rotating shaft 504 at one end (as seen in FIG. 14) and connects to a vacuum source 606 at the other end (for example, see FIGS. 2, 3A, and 11A). The vacuum connection pipe 602 and the rotating shaft 504 may have a dynamic seal so as to allow the rotating shaft 504 to rotate relative to the vacuum connection pipe 602 while, at the same time, preventing any significant leaks between the vacuum source and the rotating shaft. The vacuum source 606 permits a vacuum pressure inside the hollow center of the shaft. The vacuum source 606 may be a vacuum pump, for example, a centrifugal pump.

Referring to FIG. 14, the rotating shaft 504 is also fixedly connected to the rotating sprocket 506 so that both the rotating shaft and sprocket rotate as one unit. For example, a clamping device 608 may be used to clamp around the rotating shaft 504 while being secured (for example, by bolts) to the face of the rotating sprocket 506. According to one embodiment, the sprocket may include a series of teeth 604 which engage with the driving belt 508 (note shown), which may be a linked chain. In another embodiment, the driving belt 508 may be a belt with a series of apertures that mate with protrusions extending from the periphery of the rotating sprocket 506. The driving belt 506 is then connected to the motor 106 which has a drive sprocket with teeth similar to the teeth 604 of the rotating sprocket 506 such that when the motor 106 is operating, the driving belt rotates the rotating sprocket 506 and the rotating shaft 504 which is connected to the sprocket. The drive sprocket may be made of a plastic material and is connected to the motor 106 with a series of nuts and bolts around the circumference of the sprocket.

The motor 106 and the vacuum pump are operated by a controller 702. The controller is also in electrical communication with a fluid level sensor 704. The controller may include one or more microprocessors, memories, displays, or the like used to carry out the monitoring and operations of the filtering apparatus. The fluid level sensor may be any known fluid level sensor known in the art and provides a signal to the controller 702 when it is determined that the level of fluid in the influent collection section 100 reaches a predetermined level. When controller receives and processes the signal, it instigates the cleaning operation on the filter by starting the motor 106 to rotate and the vacuum source 606 to pump. A proximity sensor is mounted to the motor 106 in such a way as to remain stationary while the motor is in operation. This proximity sensor can detect the presence of ferrous objects such as nuts and bolts. As the motor rotates, the proximity sensor detects the bolts that connect the drive sprocket to the motor 106 as they pass by. The proximity sensor sends a signal to the controller 702 which begins to count the number of bolts that have passed the proximity sensor. When a predetermined number of bolts have passed the proximity sensor, the controller 702 will deactivate the motor. This predetermined number of bolts is determined in such a way as to ensure that the vacuum head assemblies are in a vertical position when not in operation. This prevents the vacuum head assemblies from blocking flow to the filter modules.

Referring to FIG. 13, as the rotating shaft 504 rotates, the vacuum head assembly rotates; thus sweeping across the face of the external frame structure of the modular filter. The motor, sprocket, and shaft may cause the vacuum head assembly to rotate in a clockwise or counterclockwise direction. The rotation of the suction head may be over substantially the entire surface of the external frame structure, for example, the preferred rotation is about 1 rpm for a 360° rotation. However, a variable speed drive motor may be used as the motor 106, which may be adjusted to have a rotation of about 0.5 to 1.5 rpm. It should be noted that by using a different sprocket size, a rotation of 4 rpm can be achieved. For example, a smaller sprocket 506 allows for a faster rotational speed.

Meanwhile, the vacuum source 606 creates a negative (or vacuum) pressure in the vacuum connection pipe 602, which is subsequently connected to the hollow interior of the rotating shaft 504, the one or more apertures on the circumferential surface of the rotating shaft covered by the clamp assembly 520, the aperture 529 in the clamp assembly 520, the connector 522 connected to the aperture 529, the tube 523 connected to the connector 522, the connector 512 connected to the tube 523, and the aperture 528 of the vacuum chamber 526 connected to the connector 512. Because of the vacuum pressure in the vacuum chamber 526, a suction force is created through the apertures 524 of the face plate 510, which can be used to draw in the fluid in the chamber 203 of the modular filter via the filtering medium 204 in the reverse direction. Of course, it is noted that appropriate seals should be used between the rotating shaft 504 and the clamp assembly 520; the clamp assembly 520 and the connector 522; the connector 522 and the tube 523; the tube 523 and the connector 512; and the connector 512 and the vacuum chamber 526 so as to prevent leaks and inhibiting the suction force through the apertures 524.

The number of vacuum head assemblies can be varied according to the number of modular filters in the filtering apparatus. For example, each modular filter may have a vacuum head assembly on each side, such as seen in FIGS. 3A and 11A.

Now, the method of operating the filter apparatus will be explained. First, at least one modular filter 104 is provided in the container 102 of the filtering apparatus. The modular filter 104 may comprise a filter medium mounted on the internal frame structure forming a chamber 203 having a front side and a back side (the filter medium comprises a plurality of fibers) and an external frame structure mounted on the filter medium. The untreated fluid containing particles flows into the container 102 through the inlet 108. The untreated fluid fills up the influent collection section 110 of the container and, at the same time, the fluid flows in a first direction through the apertures of the external frame structure 208, through the filter medium 204, and into the chamber 203 of the modular filter. Once inside the chamber 203 of the modular filter, the particles entrained in the untreated fluid have been removed by the filter medium, and the fluid inside the chamber 203 has been filtered or treated. The fluid level in the influent collection section and the chamber 203 of each modular filter rises till the treated fluid can exit out the fluid outlet 210 of each modular filter and flow into the effluent collection section 112 and out through the outlet 114 (see FIGS. 3A and 3B). Alternatively, the fluid can flow through each modular filter into the effluent collection section 404 (see FIGS. 11A and 11B). The fluid level in the influent collection section, the chamber 203 of each modular filter, and the effluent collection section 404 rises till the treated fluid can exit out the outlet 114.

As the modular filters become clogged with particles entrained in the fluid to be treated, the throughput of the filtered fluid decreases while the input of the untreated fluid remains the same. As a result, the fluid level in the container begins to rise. When the fluid level rises to a predetermined level, a signal from the fluid level sensor 704 is sent to the controller 702. The controller 702 then activates the motor 106 so as to begin rotating the rotating shaft 504; thus causing the vacuum head assemblies 502 attached to the rotating shaft to sweep across the external frame structure of each modular filter. The suction head contacts the external frame structure of the modular filter of the filter medium but is not capable of contacting the plurality of fibers during cleaning operation.

The rotation of the suction head occurs over substantially an entire surface of the external frame structure in a 360° rotation (or a predetermined portion of the surface of the external frame structure), and the rotation of the suction head can be in a clockwise direction or a counter clockwise direction. The suction head may be biased against the external frame structure, which can be accomplished by a leaf spring connection between the suction head and a rotating shaft so that the amount of fluid adjacent to the modular filter (i.e., fluid not in the chamber 203 inside of the modular filter) drawn between the suction head and external frame structure is minimized.

Additionally, the controller activates the vacuum source 606 so that the vacuum head assembly begins sucking in the fluid that is contained inside the chamber 203 of the modular filter so as to dislodge the particles entrained in the filter medium. The dislodged particles then are captured by the fluid being sucked into the vacuum head assembly. In other words, a vacuum is applied to the suction head so that particles may flow in a second direction from the plurality of fibers into the suction head in which the second direction is in the opposite direction of the first direction. It is further noted that both the first and second directions may be substantially perpendicular to the front and back sides of the chamber 203 of the modular filter.

FIG. 15 shows that, when the vacuum is applied to the suction head, the sucking force of the suction head 509 causes the plurality of fibers 206 of the filter medium 204 to be drawn into the aperture 218 of the plate structure of the external frame structure 208 because of the drag force of the fluid being sucked into the vacuum chamber 526 via the apertures 524 of the suction head 509. The thickness t of the plate structure of the external frame structure 208 prevents the plurality of fibers 206 from substantially contacting the suction head 509 so as to prevent wear or damage to the plurality of fibers 206.

The particles and fluid in the vacuum head assembly then flow through the hollow shaft 504 and vacuum connection pipe 602 toward the vacuum source, which may be a vacuum pump. The particles and fluid (which may be in the form of a sludge) flow through the pump and may be expelled from the pump into a disposal system 607. The disposal system may take a variety of forms, for example, the disposal system may be a system for further treating the sludge, a system which recycles all or a portion of the sludge back into the front of the wastewater treatment system of which the filtering apparatus is a part, a digester, and/or a treatment lagoon.

After a predetermined rotation, the controller 702 deactivates the motor 106 and the vacuum source 606. The length of rotation is determined by counting the number of bolts that pass by a proximity sensor mounted to the motor 106. The bolts connect the drive sprocket to the motor 106 and are evenly arranged around the circumference of the drive sprocket. Alternatively, a signal from the fluid level sensor 704 can be sent to the controller 702 to indicate a drop in the fluid level to a predetermined low level. The controller 702 then deactivates the motor 106 and the vacuum source 606. The fluid flow continues through the modular filters during the entire backwash operation. The number of rotations can be varied, for example, less than one, one, two, three, four, or more revolutions may be used.

There may be a situation in which a modular filter may have to be removed. In such an instance, there is no need to stop operation because a modular filter can be removed while allowing the other modular filters to continue operation, as seen in FIGS. 9A to 9D. To remove a modular filter 104, the fluid outlet 210 is disconnected from the output duct 116. The handle 212 is pulled upward as indicated by the arrow A to remove the protrusion 224 from the tracks 302. Once the tracks are clear of the protrusions 302, the modular filter can be turned, such as in the direction of the arrow B, if desired, and pulled out of the container 102. With the configuration shown in FIGS. 9A to 9D, the modular filter can be removed from the container 102 without draining the container or disassembling the cleaning apparatus. The process can be reversed for the installation of the modular filter.

The present disclosure provides an apparatus for treating and/or filtering fluids, such as wastewater. The apparatus may include modular filters that can be cleaned without damage to the filter medium and without undue interruption to the filtering operation. The plate structures mounted on the filter medium and the configuration of the cleaning apparatus allow the suction head of the cleaning apparatus to substantially clean the entire surface of the modular filter without sucking up a substantial amount of fluid adjacent to the cleaning apparatus and the modular filter while also preventing contact with the fibers of the filter medium.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A modular filter comprising:
a filter medium forming a chamber having a front side, a back side, and a periphery, wherein the filter medium comprises a plurality of fibers; and
an external frame structure having at least one aperture, wherein the external frame structure includes at least one plate structure disposed relative to the filter medium to inhibit flow of fluid along the surface of the filter medium, the plate structure having an external surface located at a distance from the filter medium such that the plurality of fibers does not extend substantially beyond the external surface.

2. The modular filter of claim 1 in which the at least one aperture comprises a plurality of apertures.

3. The modular filter of claim 2 in which a portion of the plurality of apertures are substantially wedge-shaped.

4. The modular filter of claim 1 in which the plate structure of the external frame structure is made from at least one of a plastic material and a fiberglass material.

5. The modular filter of claim 4 in which the plate structure of the external frame structure is made from at least one of PVC, polyethylene, and polypropylene.

6. The modular filter of claim 1 in which an overall cross-sectional shape of the modular filter is either polygonal or circular.

7. The modular filter of claim 6 in which the overall cross-sectional shape of the modular filter is one of substantially circular, semicircular, hexagonal, a hexagon cut in half, octagonal, an octagon cut in half, and rectangular.

8. The modular filter of claim 1, further comprising a fluid outlet for the chamber.

9. The modular filter of claim 8 in which the fluid outlet is at a top of the chamber.

10. The modular filter of claim 1, further comprising an internal structure on which the filter medium is attached to form the chamber.

11. The modular filter of claim 1 in which the filter medium includes a pile fabric.

12. The modular filter of claim 1 in which the plate structure of the external frame structure comprises a first plate structure mounted on the front side of the chamber and a second plate structure mounted on the back side of the chamber in which the first and second plate structures have thicknesses greater than the lengths of the plurality of fibers.

13. The modular filter of claim 1 in which the thickness of the at least one plate structure is substantially uniform.

14. The modular filter of claim 1 in which the external surface is located at a distance from the filter medium such that the plurality of fibers do not extend to the external surface.

15. The modular filter of claim 1 in which the at least one plate structure is disposed adjacent the filter medium and the fibers extend into the aperture.

16. A filtering apparatus comprising:
a container; and
at least one modular filter placed in the container, wherein the modular filter comprises a filter medium forming a chamber having a front side, a back side, and a periphery, and an external frame structure with at least one plate structure disposed relative to the filter medium to inhibit flow of fluid along the surface of the filter medium,
wherein the filter medium comprises a plurality of fibers, and
wherein the at least one plate structure has an external surface located at a distance from the filter medium such that the plurality of fibers does not extend substantially beyond the external surface.

17. The filtering apparatus of claim 16 in which the at least one modular filter comprises a plurality of modular filters placed in the container.

18. The filter apparatus of claim 16 in which the container comprises tracks in which the at least one modular filter slides therein.

19. The filtering apparatus of claim 16 further comprising at least one vacuum head assembly comprising at least one suction head, which contacts the external frame structure of the at least one modular filter.

20. The filtering apparatus of claim 19 in which the at least one suction head does not substantially contact the plurality of fibers during a cleaning operation.

21. The filtering apparatus of claim 19 in which the at least one suction head does not make any contact with the plurality of fibers during a cleaning operation.

22. The filtering apparatus of claim 19 in which the at least one suction head is biased against the external frame structure such that a substantial seal is created which substantially inhibits fluid flow between an interface of the suction head and the external frame structure.

23. The filtering apparatus of claim 22 in which a leaf spring connection between the at least one suction head and a rotating shaft biases the suction head against the external frame structure.

24. A method of operating a filter apparatus, comprising:
providing at least one modular filter in which the modular filter comprises a filter medium forming a chamber having a front side, a back side, and a periphery, and an external frame structure mounted on the filter medium, wherein the filter medium comprises a plurality of fibers;
flowing fluid containing particles through the modular filter in a first direction between the plurality of fibers and into the chamber; and
providing at least one vacuum head assembly comprising at least one suction head, which contacts the external frame structure of the at least one modular filter but does not substantially contact the plurality of fibers during a cleaning operation.

25. The method of operating of claim 24, further comprising a step of rotating the at least one suction head over substantially an entire surface of the external frame structure.

26. The method of claim 24 in which the at least one suction head is biased against the external frame structure.

27. The method of claim 26 in which a leaf spring connection between the suction head and a rotating shaft biases the suction head against the external frame structure.

28. The method of claim 27 in which the suction head is biased against the external frame structure such that a substantial seal is created which substantially inhibits fluid flow between an interface of the suction head and the external frame structure.

29. The method of claim 24, further comprising a step of rotating the suction head with the rotating shaft in a 360° rotation in at least one of a clockwise direction and a counter clockwise direction.

30. The method of claim 24 in which the step of providing the at least one modular filter comprises providing a plurality of modular filters in a single container.

31. The method of claim 30 in which the step of providing the at least one vacuum head assembly comprises providing at least one vacuum head assembly for each modular filter.

32. The method of claim 31 in which the step of providing the at least one vacuum head assembly for each modular filter comprises providing two vacuum head assemblies for each modular filter.

33. The method of claim 30 in which each modular filter is operated to filter particles from the fluid containing particles, and further comprising a step of removing at least one of the plurality of modular filters from the single container while continuing to filter the fluid containing particles with at least one of the plurality of modular filters.

34. The method of claim 24, further comprising a step of applying a vacuum to the at least one suction head in which particles flow in a second direction from the plurality of fibers into the suction head.

35. The method of claim 34 in which the second direction is opposite to the first direction.

36. The method of claim 34 in which the first and second directions are perpendicular to the front and back sides of the chamber.

37. A cleaning device for cleaning a modular filter comprising:
a hollow shaft;
a motor operatively connected to the hollow shaft;
a vacuum source in fluid communication with the hollow shaft; and
a suction head comprising a plurality of apertures in which the plurality of apertures are in fluid communication with the vacuum source via the hollow shaft,
in which the suction head is connected to the hollow shaft by a leaf spring for biasing the suction head against the modular filter.

38. The cleaning device of claim 37 in which the apertures in the suction head are arranged in rows.

39. The cleaning device of claim 37 in which the motor is configured to rotate the suction head about the rotating shaft in at least one of a clockwise and a counterclockwise direction.
